(19) United States
(12) Patent Application Publication
(10) Pub. No.: US 2008/0257447 A1
(43) Pub. Date: Oct. 23, 2008

(54) Method for Conditioning a Flexible Container Holding a Viscous Product

(75) Inventors: Frederic Mauger, Changy (FR); Julien Craplet, Cran (FR); Frederic Jean, Leverkusen (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: RHODIA CHIME

(21) Appl. No.: 11/813,169

(22) PCT Filed: Dec. 28, 2005
(86) PCT No.: PCT/EP05/57204

§ 371 Date: Jun. 19, 2008

(30) Foreign Application Priority Data
Dec. 31, 2004 (FR) 0453281

(51) Int. Cl. B67D 5/02

(52) U.S. Cl. 141/2; 141/114; 141/382

(57) ABSTRACT

The invention concerns a method for conditioning a viscous product contained in storage containers having a capacity ≧50 l, preferably ≧100 l, in volume units adapted to utilization and having a capacity ≧50 l, preferably ≧10 l, said viscous product being preferably selected among the group whereof the viscosity is not less than 10 Pa's and, preferably ranging between 10 Pa's and 200 000 Pa's.

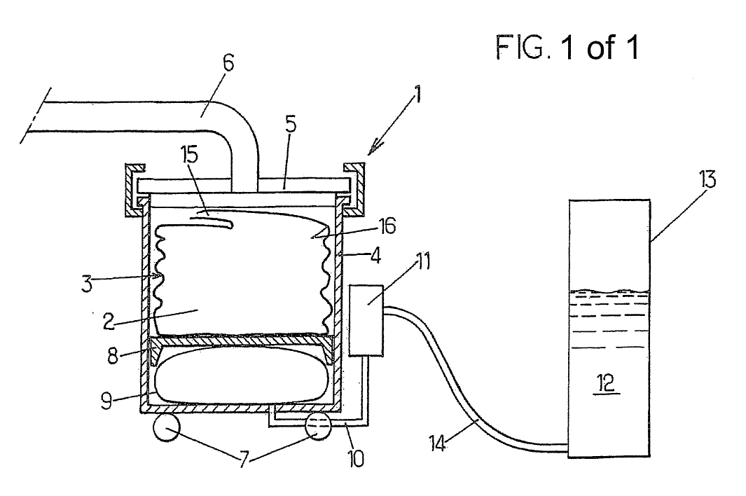

The present invention relates to a continuous or batch method for packaging a viscous product contained in storage containers having a capacity ≧50 l, preferably ≧100 l, into volume units suitable for use and having a capacity ≧50 l, preferably ≧10 l. The containers for storing the viscous product are advantageously flexible containers, in particular of the “big bag” type, and the volume units for packaging are, for example, cylindrical cartridges, boxes of any shape made from metal, glass, plastic, paper or cardboard, whether aluminized or not.

The invention also relates to draining equipment, especially including a mobile and self-contained machine for discharging the viscous product from the flexible containers.

The viscous products which the invention concerns are more especially products whose viscosity is at least 10 Pa·s and preferably between 10 Pa·s and 200 000 Pa·s, this viscosity being measured in a manner known per se at 25° C. and with a shear rate of 0.01 s⁻¹. As examples of viscous products, mention may be made of:
silicones, preferably silicone oils, silicone gums, polyorganosiloxane compositions (optionally in the form of aqueous emulsions) that can be crosslinked into elastomers by polyaddition, polycondensation or dehydrogenation/(poly)condensation reactions;
organic polymers comprising reactive organosilicone groups (known as MS polymers);
filled compositions, in a solvent or aqueous medium, comprising an acrylic polymer and that can be crosslinked into elastomers by drying;
food products;
agri-food products;
paints; and
inks.

Such viscous products may be stored in bulk in flexible containers of the “big bag” type, before being packaged into other packagings of lower volume.

The high viscosity of these pasty products is naturally a significant technical constraint for their handling, especially with a view to packaging them.

In a field similar to that of the invention, namely the field of low-flow granular/powdered materials, Patent Application DE-A-34 29 167 describes a method and a device for draining flexible containers for bulk particulate products. According to this document, the flexible “big bag” type container is, on the one hand, suspended using the handles with which it is equipped, and on the other hand, housed in a hopper, which is shaken by means of an eccentric foot that can be rotated and two other feet mounted on springs. This vibrational draining device does not appear suitable for viscous products contained in flexible bags. Techniques are also known for draining viscous products from rigid barrels using a barrel press comprising a pressure plate intended to penetrate into and to be moved in a barrel, in order to discharge, under pressure, the viscous product contained in a thin plastic bag, for example made of polyethylene.

There are also ways of draining extrudates that contain a viscous silicone product using a device formed from a tube intended to receive the extrudate and in which a piston can be moved to pressurize the viscous product, thus enabling its discharge from the tube.

The broad technological background furthermore comprises systems for draining containers composed of a rigid cardboard box containing a thin polyethylene bag filled with viscous products. This type of container is drained using a pressure plate suitable for discharging the viscous product from the polyethylene bag, said viscous product then being collected by pumps provided for this purpose, in order to be conveyed to downstream components.

The latter three known technologies lie outside of the scope of the invention, which concerns the draining of flexible “big bag” type containers, different from the specialized and expensive containers used in these technologies (barrels, tanks, steel containers or special cardboards).

Patent Application PCT WO-A-2004/074164 discloses a method of draining flexible containers for viscous products, that is easy to implement and economical. This application also describes draining equipment used in implementing the method. The viscous products are chosen from the group of products having a viscosity between 10 Pa·s and 200,000 Pa·s., e.g. namely silicone oils or gums.

This draining method mainly consists in: using a flexible container; optionally moving the container to be emptied from its storage site to a drainage site; ensuring that at least one outlet opening, preferably positioned in the lower part of the container, allows the viscous product to flow out of the container; exerting a pressure on at least one defined area of the flexible container using pressurization means, preferably composed of at least one pressure member and/or one pressure fluid, so as to, on the one hand, maintain the container in the inflated or partially inflated state and, on the other hand, to accelerate the flow; depressurizing at the end of draining.

The drainage device comprises, on the one hand, a pressure member comprising at least one piston and, on the other hand, at least one drainage tank intended to receive the flexible container. In practice, the pressure member is a very expensive, very bulky and very heavy (4 to 5 tonnes) stationary hydraulic press. Such a hydraulic press is permanently allocated to a single packager of the viscous product into packages of smaller volumes than the “big bags”, for example silicone sealant cartridges. Therefore at least one hydraulic press is required per packager.

It is clear that the bulkiness of a hydraulic press is an industrial handicap, as space is limited. The heavy weight of hydraulic presses requires expensive civil engineering work, able to support them.

These hydraulic presses also pose other problems. Indeed, such presses are long-term investments that take a long time to depreciate, and this is even more the case as it is penalizing on the production schedule to have a single stationary draining press per packager. Indeed, such a configuration makes it necessary, for each change of flexible container holding the viscous product, to interrupt the operation of the packager for the time required to replace the empty container with a full container. This operation is not only a brake on the productivity, it is also long and therefore expensive in labor terms. Furthermore, it would be totally unrealistic to provide two stationary presses per packager, in order to replace the containers concurrently and thus not to upset the packaging output. Two unacceptable obstacles at least preclude this route, namely the cost and bulkiness of stationary hydraulic presses.

Within this context, one of the main objects of the present invention is to improve and/or provide an alternative to the invention described in the Application PCT WO-A-2004/074164, by providing a method, which is easy to implement and of low cost, for packaging a viscous product contained in storage containers having a capacity ≧50 l, preferably ≧100 l, into volume units suitable for use and having a capacity ≧50 l, preferably ≧10 l.

Within this context, one of the main objects of the present invention is to provide a method for packaging a bulk viscous product into volume units suitable for use and having a low volume (≦10 l), this method having to be flexible and to allow “big bags” supplying a packaging line to be changed concurrently.

One of the other main objects of the present invention is to provide a method for packaging a bulk viscous product into volume units suitable for use and having a low volume (≦10 l), this method having to entail little loss of substance, for example less than or equal to 1.5%, even less than or equal to 0.8%, and which requires only very little or no cleaning of the material used.

One of the other main objects of the present invention is to supply equipment for packaging a bulk viscous product (“big bag”) into volume units suitable for use and having a low volume (≦10 l), which are of light structure, not very bulky, simple, economical and of low cost, which make it possible to empty flexible bags having a capacity greater than or equal to 250 liters which are easy to use, which only generate very low loss of substance (less than or equal to 1.5%) and which require little or no cleaning.

One of the other main objects of the invention is to supply equipment for packaging a bulk viscous product (“big bag”) into volume units suitable for use and having a low volume (≦10 l), which optimally correspond to industrial transport and logistics requirements.

These objects, amongst others, are achieved by the present invention which firstly relates to a method for packaging a viscous product contained in storage containers having a capacity ≧50 l, preferably ≧100 l, into volume units suitable for use and having a capacity ≦50 l, preferably ≦10 l,

said viscous product preferably being chosen from the group of products whose viscosity is at least 10 Pa·s and preferably between 10 Pa·s and 200 000 Pa·s, characterized in that:
a) flexible containers are used as storage containers having a capacity ≧50 l, said flexible containers each comprising at least one, optionally sealed, outlet passage;
b) optionally each flexible container is stored in a rigid box that can be dismantled, preferably made of folding cardboard;
c) the flexible containers are optionally removed from their storage boxes;
d) the flexible containers are transferred from their storage site to a packaging site;
e) at least one mobile and self-contained machine for discharging the viscous product out of the flexible containers is used, combined with at least one packager of the viscous product, into the units suitable for use and having a capacity ≧50 l;
f) the outlet passage is opened, if it was sealed, thus allowing the discharge of the viscous product out of the container;
g) the viscous product is discharged using the mobile and self-contained discharge machine;
h) the discharged viscous product is conveyed to the packager; and
i) the packager is made to fill the units that are suitable for use and having a capacity ≧50 l with the desired dose.

The Inventors have succeeded in developing a packaging methodology comprising drainage by discharging viscous products out of flexible containers, to supply a packager, in which it is anticipated to use at least one mobile and self-contained machine for discharging the viscous product, which provides the following advantages:
low bulkiness;
low weight;
low cost;
flexibility;
possibility of changing “big bag” containers concurrently for several packagers with an additional mobile and self-contained discharge machine, and hence an improvement in the productivity of around 300 t/year (instead of 700 to 1200 t/year with a stationary press); and
the mobile and self-contained discharge machine may be combined, on a packager, with a stationary hydraulic press.

Preferably, each packager of the viscous product into the units suitable for use and having a capacity ≦50 l, is combined with at least one mobile and self-contained machine for discharging the viscous product out of the containers.

One of the main features of the invention is the use of mobile and self-contained machines for discharging the viscous product, but for all that it does not exclude the possible presence of stationary machines for discharging the viscous product combined with mobile and self-contained machines.

According to one even more preferred embodiment of the method according to the invention, at least two packagers and at least one additional mobile machine for discharging the viscous product out of the flexible containers are used, making it possible to operate concurrently, the mode of implementation being preferably chosen from the group comprising:
the mode in which there are one mobile and two stationary machines for the discharge of rigid containers, per pair of packagers;
the mode in which there are two mobile machines for draining flexible containers and one stationary machine for draining rigid containers, per pair of packagers; and
the mode in which there are three mobile machines for draining flexible containers, per pair of packagers.

One of the main features of the invention is therefore the use of a mobile and self-contained discharge machine, which may easily be moved from one packager to another and which is self-contained as regards the draining by discharge of the viscous product out of the flexible container. In order to do this, it is equipped with discharge means which are themselves also mobile, light, of low cost and are not very bulky.

The method according to the invention offers a wide range of drainage rates, which can be varied depending on the viscosity of the product in question, on the outlet diameter or on the pressure value exerted.

According to a preferred feature of the invention, for the discharge according to step g):
g1) a pressure is exerted on at least one area defining the flexible container using pressurization means belonging to the mobile machine and, preferably, composed of at least one pressure member and/or a pressure fluid, so as to, on the one hand, maintain the container in the inflated or partially inflated state and, on the other hand, to enable the discharge of the viscous product; and/or
g2) the viscous product is pumped; and
g3) if necessary, depressurizing at the end of the discharge.

Advantageously, the mobile machine for discharging the viscous product out of the flexible containers comprises a tank intended to receive a flexible container.

In accordance with the method according to the invention, step e) consists in using at least one mobile and self-contained discharge machine, which comprises at least one pressure member comprising at least one piston intended to exert a pressure on the flexible container.

More specifically, it is advantageous to use at least one mobile and self-contained discharge machine that comprises a tank designed so as to be able to be closed, the piston of said machine being able to move under the action of a pressure fluid, so as to discharge the viscous product out of the tank.

According to a preferred embodiment of the method according to the invention, a pressure fluid contained in an inflatable jack is used, this jack being housed between the piston and a reversible sealing lid of the tank or the bottom of the tank and connected to pressure fluid supply means equipping the mobile and self-contained discharge machine, said pressure fluid supply means enabling the inflation and consequently the movement of the piston, to make it possible to discharge the viscous product out of the tank.

The pressure fluid used may be a gas or a liquid. It may be a liquid having a viscosity of less than or equal to 50 Pa·s. Water would be perfectly suitable for this purpose.

According to the method, the mobile and self-contained machine that is preferably chosen comprises a pump for extracting the viscous product and a follower plate intended to rest on the flexible container when said machine is not operating and throughout the draining of the flexible container.

Advantageously, the viscous product is chosen from the group comprising:
silicones, preferably silicone oils, silicone gums, polyorganosiloxane compositions (optionally in the form of aqueous emulsions) that can be crosslinked into elastomers by polyaddition, polycondensation or dehydrogenation/(poly)condensation reactions;
organic polymers comprising reactive organosilicone groups (known as MS polymers);
filled compositions, in a solvent or aqueous medium, comprising an acrylic polymer and that can be crosslinked into elastomers by drying;
food products;
agri-food products;
paints; and
inks.

As examples of viscous products relating to the invention, mention may be made of the products whose viscosity is around 3000 Pa·s, such as silicone sealants.

According to one advantageous feature of the method according to the invention, the outlet opening or openings of the container is (are) obtained by:
cutting into the wall of the container; and/or
removing lid(s) or caps equipping one or more orifices, said orifices possibly being provided with drainage spouts in the wall of the container; and/or
removing one or more ties that close the opening or openings already provided in the container.

In practice, it is therefore possible to cut out part of the wall of the flexible container or optional spouts equipping the latter, or else to undo the ties and/or knots closing an opening.

According to one advantageous variant, the viscous product discharged from the flexible container, or optionally from its lining bag alone, supplies storage means and/or mechanical means for moving the viscous product that enable its flow rate to be increased, said mechanical means preferably being chosen from the group comprising: pumps and (twin-)screws.

Although the method according to the invention operates without mechanical collection of the viscous product at the container outlet, it is quite feasible to provide boosting by mechanical components (for example: pumps, screws, twin-screws) for the viscous product discharged, in the cases where it would be necessary to transport it over a large distance or through ducts generating large pressure drops, or else in order to derive an economic advantage therefrom.

In the method according to the invention, the viscous product discharged from the flexible container supplies at least one assembly for packaging said product into a suitable packaging, at a suitable flow rate that is greater than or equal to the input of the packager.

Although, in the case of a simple discharge draining, the flow rate is advantageously as high as possible, (for example greater than 50 liters per minute for a viscous product of 1000 Pa·s) so as to provide maximum productivity, in the case of supplying a packager, it is desirable to be able to provide high instantaneous flow rates (for example, which may be greater than 1 liter per minute). The flow rate naturally depends on all the parameters of Poiseuille's law (viscosity, pressure difference, geometry of the outlet duct) and on the components including the outlet of the viscous product: valves, filters, roughness.

By way of illustration, it may be specified that the packager could be, in particular, a device for cartridging viscous products, especially silicone sealants (“cartridger”) at a suitable flow rate that is at least equal to the input of the packaging assembly.

According to another advantageous version of the invention, the viscous product discharged from the flexible container supplies mechanical means for moving the viscous product interposed between the mobile and self-contained discharge machine and enabling its flow rate to be increased, said mechanical means preferably being chosen from the group comprising: pumps and (twin-) screws.

Naturally, the method according to the invention is not limited as to the number of mobile and self-contained discharge machines, stationary discharge machines, packagers, and optional storage or mechanical collection means positioned downstream.

For the discharge, the flexibility of the container holding the viscous product is exploited, by applying, to the wall of this flexible container, a pressure that is almost entirely transferred to the viscous product, so that the container is kept in an at least partially inflated state and the viscous product is discharged. This continuous or batch discharge of the viscous product takes place through an opening made in the flexible container (for example, by cutting, unscrewing a lid, or through a drainage spout). The inflated state of the flexible container that results from the pressure exerted on only one part of its surface makes it possible to maintain a permanent pressure on the wall of the container and thus eliminates the risk of random folding that is liable to obstruct the opening through which the viscous product emerges.

The pressure exerted is, for example, between 1 and 6 bar in the case of direct drainage by discharge, whereas it is adjusted so that the outlet flow rate of the viscous product is greater than or equal to the input of the packager placed downstream of the mobile and self-contained discharge machine.

According to another of its aspects, the present invention relates to an item of equipment for implementing the method defined above, which equipment being characterized in that it comprises:
a viscous product chosen from the group of products having a viscosity greater than or equal to 50 Pa·s, preferably between 100 Pa·s and 10 000 Pa·s,
flexible storage containers having a capacity ≧50 l, said flexible containers each comprising at least one, optionally sealed, outlet passage;
at least one mobile and self-contained machine for discharging the viscous product out of the flexible containers, combined with at least one packager of the viscous product, into the units suitable for use and having a capacity ≧50 l; and
optionally mechanical means for moving the viscous product that enable its flow rate to be increased, said mechanical means preferably being chosen from the group comprising: pumps and (twin-)screws.

The flexible container is, for example, of the “big bag” type. Advantageously, it is a container of which the wall, in order to be flexible, does not remain less mechanically strong and has, furthermore and preferably, sealing properties with regard to the viscous product in question.

According to a preferred feature of the invention, this wall is mainly composed of:
at least one component ensuring the mechanical strength and comprising one or more layers of materials that are identical to or different from each other, preferably made of fabric; and optionally
at least one sealing component formed from (i) at least one polymer film, preferably in the form of a coating and/or (2i) at least one leaktight lining bag composed of one or more layers of materials chosen from the group comprising: synthetic polymer films (in particular polyolefines {and even more preferentially polyethylenes or polypropylenes}, polyesters or polyamides), or metals (in particular aluminum); the lining bag or bags, being at least partly attached to the wall component ensuring the mechanical strength, and, more preferentially still, at least partly bonded and/or stitched to said component.

This container formed by such a flexible envelope is a sufficient packaging in terms of protection of the viscous product. It is a self-contained packaging which can be transported easily, for example by simply being placed on a pallet and secured, or else enclosed in other containers that are not involved in the draining method, unlike the thin polyethylene bags which, in a known manner, are housed in rigid containers that are used both for transporting and draining them.

The container having a flexible envelope used in the method according to the invention may be, for example, a fabric (e.g. polypropylene) bag lined with a thin, for example multilayered (polyethylene/aluminum/polyethylene terephthalate) bag bonded and/or stitched to the fabric, said container being optionally and advantageously equipped with handles enabling it to be suspended from and handled by a hoist or forklift truck.

These flexible or “big bag” containers may have large capacities, for example between 500 and 2000 liters.

Advantageously, the container having a flexible envelope may be disposable, which is a source of cost saving, especially in terms of transport and storage. This makes it possible to avoid complicated supply-chain rotations of metal containers.

Even more preferably, the flexible container has a mechanically strong and leaktight wall that is made based on fabric(s) whose weight in the uncoated state is in the range of 100 to 300 g/m² and in that the lining bag has a thickness in the range of 5 to 500 microns.

In practice, it could be a polypropylene fabric having a density equal to 150-300 g/m² for a 1000 liter container.

The lining bag is, for example, bonded or stitched to the inside or outside of the mechanically strong wall. This thin lining bag may have a thickness between 10 and 250 microns. It should be noted that the fabric thicknesses of the wall and of the lining bag depend on the desired mechanical strength and physicochemical protection.

Optionally, the flexible container is equipped with one or more drainage spouts, having a structure that is identical to or different from that of the flexible container.

Naturally, each spout optionally provided on the flexible container may be used for draining or filling said container and may, in addition, act as a closure for an opening, for example by means of a lid or a knotted tie. This lid may consist of a weld and/or an adhesive joint.

Each optional spout may furthermore constitute a component for connecting the flexible container to a downstream means of storage for mechanical collection or packaging.

According to one advantageous variant, the flexible container comprises at least one large opening or so-called complete opening that facilitates filling. This large opening may be closed by welding and/or by a knot and/or by an adhesive joint. It is preferable that such a large opening is only used for filling, unlike the openings and/or spouts for drainage as described above.

Preferably, the mobile and self-contained discharge machine comprises:
at least one pressure member comprising at least one piston intended to exert a pressure on the flexible container and which is able to move under the action of a pressure fluid, so as to discharge the viscous product out of the tank;
a tank:
   comprising at least one outlet opening for the viscous product;
   equipped with a reversible closure lid;
   equipped with means of movement (preferably castors); and
   preferably composed of a hollow cylinder intended to receive the flexible container and in which the head of the piston is able to slide, this head preferably being circular and having a diameter sufficiently close to the inside diameter of the tank so that the sealing with regard to the viscous product may be ensured, advantageously with the help of a peripheral O-ring pushing against the preferably chamfered edge of the head of the piston and against the inner wall of the tank;
at least one inflatable jack intended to receive the pressure fluid housed between the piston and a closure lid of the tank or the bottom of the tank;
pressure fluid supply means for the inflatable jack, said pressure fluid supply means enabling the inflation and consequently the movement of the piston, in order to enable the discharge of the viscous product out of the tank; and
optionally at least one pump for extracting the viscous product and at least one follower plate intended to rest on the flexible container when said machine is not operating and during the draining of the flexible container.

Advantageously, the mobile and self-contained discharge machine comprises at least one pressure fluid reservoir and a conduit, connecting the pressure fluid reservoir to the inflatable jack.

In practice, the pressure fluid is, for example, chosen from the group of incompressible fluids, preferably from the subgroup of liquids, e.g. having a viscosity less than 50 Pa·s, comprising water or oil or from the group of compressible fluids, air being preferred.

So that the pressure fluid can exert a pressure on the flexible container, it is important that the drainage tank be designed as an autoclave provided with at least one orifice which may be opened or closed and be used to introduce and/or remove the pressure fluid. Naturally, this pressure-sealed drainage tank also comprises at least one drainage opening for the viscous product.

The method and the equipment for packaging a viscous product contained in flexible containers of “big bag” type, into volume units suitable for use and having a capacity of less than 50 liters, preferably less than 10 liters (for example, a cartridge) will be better understood in the light of the description that follows, of an advantageous exemplary embodiment of one of the main means of the invention, namely the mobile and self-contained machine for discharging the viscous product out of the flexible containers. This description is given with reference to the appended drawing in which the single FIGURE represents a block diagram of said mobile and self-contained machine for discharging the viscous product.

The single FIGURE shows a mobile and self-contained machine 1 for discharging a viscous product 2 contained in a flexible container 3.

The latter is placed inside a tank 4, open at its upper end and of a generally cylindrical shape having a flat bottom. The upper open end of this tank 4 is hermetically sealed, reversibly, by a lid 5.

This lid 5 comprises an orifice linked to an outlet duct 6 conveying the viscous product 2 toward a packager contained in the packaging equipment according to the invention but not shown in the drawing.

The tank 4 (for example having a capacity of 1000 liters and for example made of stainless steel) is equipped with castors 7 enabling it to be easily moved, for example from the storage site for the flexible containers 3 toward a packager and vice versa.

According to one variant, the castors 7 could be replaced with other suitable means for conferring mobility on the machine 1. It could for example be a pallet enabling the machine 1 to be transported using a lifting and handling device.

The flexible container 3 or “big bag” for the viscous product 2 lies inside the tank 4 on a pressure member composed of a mobile piston 8. This pressure piston 8 has a maximum outside diameter that is slightly smaller than the inside diameter of the tank 4 (for example 0.1 to 2.5% smaller) so as to be able to slide easily.

A flexible inflatable jack 9 is housed in the tank 4 between the pressure piston 8 and the bottom of the tank 4. This flexible inflatable jack 9 may be, for example, of the type of those sold by PRONAL.

The supply of pressure fluid to the flexible inflatable jack 9 is carried out via a conduit 10 passing into the bottom of the tank 4 and connected at its outer end to means 11 (pump) for conveying the pressure fluid 12 contained in a reservoir 13. The reservoir 13—pump 11 connection is provided by a conduit 14.

Advantageously, the pressure fluid 12 may be an incompressible fluid, for example a liquid such as water or oil, or else a compressible fluid such as air. In the example represented in the drawing, it is an incompressible fluid 12 (or oil); in such a case in question, it is advantageous to provide according to one variant, a cushion filled with compressible gas, for example air, inside the inflatable jack 9. Such an air cushion acts as a buffer smoothing the flow rate of the pressure fluid 12 and limiting, even eliminating, the lag time for the discharge or flow of the viscous product 2 to the outside of the tank 4 via the outlet duct 6.

The flexible container 3 housed inside the tank 4 has an outlet passage 15 for the viscous product 2. This passage 15 is provided in the upper part of the flexible container 3; during storage of the flexible container holding viscous products this outlet passage 15 is sealed. Sealing of the outlet passage 15 is carried out by any suitable means known to a person skilled in the art, for example: tying, heat welding, stitching, bonding, stapling, etc.

This outlet passage 15 is positioned in the vicinity of the orifice of the lid 5 linked to the outlet duct 6 toward the packager.

The opening of this outlet passage 15 is carried out just before the discharge of the viscous product, that is to say just before the flexible container 3 is pressurized by the pressure piston 8 activated by the inflatable jack 9.

The flexible container 3 has an envelope 16 which may be composed of:
either a multilayer of mechanically strong walls (for example made of polypropylene fabric)/thin polyethylene bags optionally stitched and or bonded to the inside of the fabric wall;
or the lining bag only after it has been extracted from inside the flexible container 3.

The flexible container 3 must be designed so as to ensure minimal loss of material, in particular less than 2%.

Preferably, the flexible container 3 is a container of “big bag” type having a cylindrical bottom, without vertical stitching, of which the diameter is slightly less than that of the tank 4, so that the inflation undergone by this flexible container during pressurization keeps the wall of the flexible container 3 under pressure during draining. In this case, this wall is composed of a polypropylene fabric comprising a bonded inner layer formed from a thin bonded polyethylene lining bag. This type of mechanically strong wall has a protective role during transport and storage, whereas its inner layer (inliner) ensures leaktightness during drainage, so that the viscous product only flows through the drainage opening of the envelope of the flexible container when this is pressurized.

According to one variant, the leaktightness between the head of the pressure piston 8 and the inner face of the tank 4 may be ensured by an O-ring, not shown in the drawing, which forms a barrier to the migration of the viscous product 2 into the variable volume compartment of the tank 4 containing the inflatable jack 9.

This embodiment with the flexible inflatable jack 9 is simple to implement and inexpensive. This is furthermore a light pressure member, which is not bulky, and which contributes to the advantages of the mobile and self-contained machine 1.

The latter has an additional advantage of being quickly assembled and disassembled.

According to one optional feature, the lid 5 of the tank 4 may be equipped with a pressure relief valve to release excessive air pressure.

The operation of the mobile and self-contained machine 1 consists simply in inflating the flexible jack 9 using a pressure fluid, so as to compress the flexible container 3 and to thus discharge the viscous product 2 contained in this flexible container 3 to the outside of the tank 4 via the outlet duct 6 in the direction of the packager not shown in the drawing.

1. A method for packaging a viscous product contained in storage containers having a capacity ≧50 l, preferably ≧100 l, into volume units suitable for use and having a capacity ≦50 l, preferably ≦10 l,
said viscous product preferably being chosen from the group of products whose viscosity is at least 10 Pa·s and preferably between 10 Pa·s and 200 000 Pa·s, wherein:
a) flexible containers (3) are used as storage containers having a capacity ≧50 l, said flexible containers each comprising at least one, optionally sealed, outlet passage (9);
b) optionally each flexible container is stored in a rigid box that can be dismantled, preferably made of folding cardboard;
c) the flexible containers are optionally removed from their storage boxes;
d) the flexible containers are transferred from their storage site to a packaging site;
e) at least one mobile and self-contained machine for discharging the viscous product (2) out of the flexible containers (3) is used, combined with at least one packager of the viscous product (2), into the units suitable for use and having a capacity ≦50 l;
f) the outlet passage (9) is opened, if it was sealed, thus allowing the discharge of the viscous product (2) out of the container (3);
g) the viscous product (2) is discharged using the mobile and self-contained discharge machine;
h) the discharged viscous product (2) is conveyed to the packager; and
i) the packager is made to fill the units that are suitable for use and having a capacity ≦50 l with the desired dose.

2. The method as claimed in claim 1, wherein each packager of the viscous product (2) into the units suitable for use and having a capacity ≦50 l, is combined with at least one mobile machine for discharging the viscous product (2) out of the containers.

3. The method as claimed in claim 2, wherein at least two packagers and at least one additional mobile machine for discharging the viscous product (2) out of the flexible containers are used, making it possible to operate concurrently, the mode of implementation being preferably chosen from the group I comprising:
the mode in which there are one mobile and two stationary machines for the discharge of rigid containers, per pair of packagers;
the mode in which there are two mobile machines for draining flexible containers and one stationary machine for draining rigid containers, per pair of packagers; and
the mode in which there are three mobile machines for draining flexible containers, per pair of packagers.

4. The method as claimed in claim 1, wherein for the discharge according to step g):
g1) a pressure is exerted on at least one area defining the flexible container (3) using pressurization means belonging to the mobile machine and, preferably, composed of at least one pressure member (8) and/or a pressure fluid, so as to, on the one hand, maintain the container (3) in the inflated or partially inflated state and, on the other hand, to enable the discharge of the viscous product (2); and/or
g2) the viscous product is pumped; and
g3) if necessary, depressurizing at the end of the discharge.

5. The method as claimed in claim 1, wherein the mobile machine for discharging the viscous 1 product (2) out of the flexible containers (3) comprises a tank (4) intended to receive a flexible container (3).

6. The method as claimed in claim 4, wherein in step e), at least one mobile and self-contained discharge machine is used, which comprises at least one pressure member (8) comprising at least one piston (8) intended to exert a pressure on the flexible container (3).

7. The method as claimed in claim 6, wherein at least one mobile and self-contained discharge machine is used that comprises a tank (4) designed so as to be able to be closed, and in that the piston (8) of said machine is able to move under the action of a pressure fluid, so as to discharge the viscous product (2) out of the tank (4).

8. The method as claimed in claim 7, wherein a pressure fluid contained in an inflatable jack is used, this jack being housed between the piston (8) and a reversible sealing lid of the tank (4) or the bottom of the tank (4) and connected to pressure fluid supply means equipping the mobile and self-contained discharge machine, said pressure fluid supply means enabling the inflation and consequently the movement of the piston (8), to make it possible to discharge the viscous product (2) out of the tank (4).

9. The method according to claim 1, wherein the mobile and self-contained machine comprises a pump for extracting the viscous product (2) and a follower plate intended to rest on the flexible container when said machine is not operating and throughout the draining of the flexible container.

10. The method according to claim 1, wherein the viscous product (2) is chosen from the group comprising:
silicones, preferably silicone oils, silicone gums, polyorganosiloxane compositions (optionally in the form of aqueous emulsions) that can be crosslinked into elastomers by polyaddition, polycondensation or dehydrogenation/(poly)condensation reactions;
organic polymers comprising reactive organosilicone groups (known as MS polymers);
filled compositions, in a solvent or aqueous medium, comprising an acrylic polymer and that can be crosslinked into elastomers by drying;
food products;
agri-food products;
paints; and
inks.

11. The method according to claim 1, wherein the opening or openings of the outlet passage or passages (9) of the container (3) is (are) obtained by:
cutting into the wall of the container (3); and/or
removing lid(s) or sealing caps; and/or
removing one or more ties that close the opening or openings already provided in the container (3).

12. The method according to claim 1, wherein the viscous product (2) discharged from the flexible container supplies mechanical means for moving the viscous product interposed between the mobile and self-contained discharge machine and that enable its flow rate to be increased, said mechanical means preferably being chosen from the group comprising: pumps and (twin-)screws.

13. An item of equipment for implementing the method of claim 1, wherein the item comprises:
a viscous product (2) chosen from the group of products having a viscosity greater than or equal to 50 Pa·s, preferably between 100 Pa·s and 10 000 Pa·s,
flexible storage containers (3) having a capacity ≧50 l, said flexible containers each comprising at least one, optionally sealed, outlet passage (15);
at least one mobile and self-contained machine for discharging the viscous product (2) out of the flexible containers (3), combined with at least one packager of the viscous product (2), into the units suitable for use and having a capacity ≦50 l; and
optionally mechanical means for moving the viscous product that enable its flow rate to be increased, said mechanical means preferably being chosen from the group comprising: pumps and (twin-) screws.

14. The equipment as claimed in claim 13, wherein the flexible container (3) has a wall composed of:
at least one component ensuring the mechanical strength and comprising one or more layers of materials that are identical to or different from each other, preferably made of fabric; and/or
at least one sealing component formed from (i) at least one polymer film, preferably in the form of a coating and/or (2i) at least one leaktight lining bag composed of one or more layers of materials chosen from the group comprising: synthetic polymer films (in particular polyolefines—and even more preferentially polyethylenes or polypropylenes—polyesters or polyamides), or metals (in particular aluminum); the lining bag or bags, when they are used, being attached to the wall component ensuring the mechanical strength, this or these bag(s) preferably being at least partly bonded and/or stitched to said component.

15. The equipment as claimed in claim 14, wherein the flexible container (3) has a mechanically strong and leaktight wall that is made based on fabric(s) whose weight in the uncoated state is in the range of 100 to 300 g/m2 and in that the lining bag has a thickness in the range of 5 to 500 microns.

16. The equipment as claimed in claim 15, wherein the mobile and self-contained discharge machine comprises:
at least one pressure member comprising at least one piston (8) intended to exert a pressure on the flexible container (3) and which is able to move under the action of a pressure fluid, so as to discharge the viscous product (2) out of the tank (4);
a tank (4):
comprising at least one outlet opening for the viscous product (2);
equipped with a reversible closure lid;
equipped with means of movement (preferably castors (7)); and
preferably composed of a hollow cylinder intended to receive the flexible container (3) and in which the head of the piston (8) is able to slide, this head preferably being circular and having a diameter sufficiently close to the inside diameter of the tank (4) so that the sealing with regard to the viscous product (2) may be ensured, advantageously with the help of a peripheral O-ring pushing against the preferably chamfered edge of the head of the piston (8) and against the inner wall of the tank (4);
at least one inflatable jack (9) intended to receive the pressure fluid housed between the piston (8) and a closure lid of the tank (4) or the bottom of the tank (4);
pressure fluid supply means for the inflatable jack, said pressure fluid supply means enabling the inflation and consequently the movement of the piston (a), in order to enable the discharge of the viscous product (2) out of the tank (4); and
optionally at least one pump for extracting the viscous product (2) and at least one follower plate intended to rest on the flexible container when said machine is not operating and during the draining of the flexible container.

17. The equipment according to claim 16, wherein the mobile and self-contained discharge machine comprises at least one pressure fluid reservoir (12) and a conduit (10, 14), connecting the pressure fluid reservoir (12) to the inflatable jack (9).

18. The equipment as claimed in claim 17, wherein the pressure fluid is chosen from the group of incompressible fluids, preferably from the subgroup comprising water or oil or from the group of compressible fluids, air being preferred.
